(19) United States
(12) Patent Application Publication
(10) Pub. No.: US 2026/0003392 A1
(43) Pub. Date: Jan. 1, 2026

(54) MASK OF HEAD-MOUNTED DISPLAY DEVICE AND HEAD-MOUNTED DISPLAY DEVICE

(71) Applicant: Beijing Zitiao Network Technology Co., Ltd., Beijing (CN)

(72) Inventors: Yunpeng WANG, Beijing (CN); Lingpeng RAN, Beijing (CN)

(21) Appl. No.: 19/075,280

(22) Filed: Mar. 10, 2025

(30) Foreign Application Priority Data
Jun. 27, 2024 (CN) 202410851661.9

(51) Int. Cl. G06F 1/16

(52) U.S. Cl. CPC G06F 1/163

(57) ABSTRACT

The present disclosure relates to the technical field of electronic products, in particular a mask of a head-mounted display device, and a head-mounted display device. The mask includes: a support extending in a first direction and a second direction orthogonal to each other, and including a main support, and a face-fitting elastic support that is disposed on a side of the main support and arranged in a bent manner, the main support being provided with a forehead cantilever and a zygomatic cantilever respectively connected to the face-fitting elastic support on both sides in the second direction, and two forehead cantilevers being provided and arranged at intervals in the first direction, and the forehead cantilever being capable of elastically bending in the first direction, and two zygomatic cantilevers being provided and arranged at intervals in the first direction.

### CROSS-REFERENCE TO RELATED APPLICATION(S)

This application claims priority to Chinese Application No. 202410851661.9 filed Jun. 27, 2024, the disclosure of which is incorporated herein by reference in its entirety.

### FIELD

The present disclosure relates to the technical field of electronic products, and in particular, to a mask of a head-mounted display device and a head-mounted display device.

### BACKGROUND

The development of near-eye technologies boosts applications of the head-mounted display device to work and life occasions, such as VR devices, AR devices, and the like. A head-mounted display device typically includes a host portion, and a mask connected to the host portion. When a user wears the head-mounted display device, the mask fits the user's face to form a closed space, to thus enhance the sense of immersion.

### SUMMARY

The present disclosure provides a mask of a head-mounted display device, and a head-mounted display device.

In a first aspect, the present disclosure provides a mask of a head-mounted display device, comprising: a support extending in a first direction and a second direction orthogonal to each other, the support comprising a main support, and a face-fitting elastic support that is disposed on a side of the main support and arranged in a bent manner:

Alternatively, the main support is provided with a forehead cantilever and a zygomatic cantilever respectively connected to the face-fitting elastic support on both sides in the second direction, and two forehead cantilevers are provided and arranged at intervals in the first direction, and the forehead cantilever is capable of elastically bending in the first direction, and two zygomatic cantilevers are provided and arranged at intervals in the first direction.

Alternatively, the forehead cantilever comprises a first cantilever and a second cantilever connected to each other, the first cantilever is connected to the main support, the second cantilever is connected to the face-fitting elastic support, the first cantilever is in a sheet form, and a plane on which the first cantilever is located is not parallel to the first direction.

Alternatively, an end of the second cantilever is connected to the first cantilever, and the other end thereof extends in the first direction away from the other forehead cantilever and is connected to the face-fitting elastic support.

Alternatively, the forehead cantilever is rotatably connected to the face-fitting elastic support, and can swing in the first direction relative to the face-fitting elastic support.

Alternatively, the face-fitting elastic support is rotatably connected to the zygomatic cantilever, such that the face-fitting elastic support can rotate at least in the first direction and/or the second direction relative to the zygomatic cantilever.

Alternatively, the mask of the head-mounted display device further comprises a ball joint structure:
the ball joint structure comprises a ball seat and a ball head, the ball seat is provided thereon with a ball socket for receiving the ball head, and one of the ball head and the ball seat is connected to the zygomatic cantilever while the other is connected to the face-fitting elastic support.

Alternatively, the face-fitting elastic support comprises a main bracket, and separate brackets connected to two ends of the main bracket in the first direction, the main bracket has an arc shape and is recessed in a middle part towards the main support, and the two separate brackets form nose pad portions of the face-fitting elastic support.

Alternatively, in the first direction, a distance between connection points of the two forehead cantilevers to the face-fitting elastic support is less than a distance between connection points of the two zygomatic cantilevers to the face-fitting elastic support.

Alternatively, the mask of the head-mounted display device further comprises a face-fitting cushion disposed on a side of the face-fitting elastic support away from the main support.

In a second aspect, the present disclosure provides a head-mounted display device, comprising the mask of the head-mounted display device provided in the first aspect.

### BRIEF DESCRIPTION OF THE DRAWINGS

The accompanying drawings, which are incorporated into the Description and formulate a part thereof, show embodiments in line with the present disclosure and explain, together with the Description, the principle of the present disclosure.

In order to make clearer the technical solution according to the embodiments of the present disclosure or the prior art, brief introduction of the drawings required in the embodiments or the prior art will be provided below. Apparently, the ordinal skill in the art could derive other drawings on the basis of these drawings, without doing creative work.

FIG. 1 illustrates a schematic diagram of a structure of a support according to embodiments of the present disclosure;

FIG. 2 illustrates a sectional view of a support according to embodiments of the present disclosure:

FIG. 3 illustrates a partial enlarged view of FIG. 2:

FIG. 4 illustrates a schematic diagram of a structure of a head-mounted display device according to embodiments of the present disclosure; and

FIG. 5 illustrates an exploded view of a head-mounted display device according to embodiments of the present disclosure.

Wherein,
1. support; 11. main support; 111. through hole; 12. face-fitting elastic support; 121. main bracket; 122. separate bracket; 13. forehead cantilever; 14. zygomatic cantilever; 15. ball joint structure; 151. ball head; 152. ball seat;
2. face-fitting cushion
10. display unit; 20. mask; 30. strap.

### DETAILED DESCRIPTION OF EMBODIMENTS

In order to make the above objective, features and advantages much clearer, description of the solution according to the present disclosure will be further detailed below. It is worth noting that the embodiments of the present disclosure and the features therein could be combined with each other if no conflict is generated.

Although lots of details will be described below for a full understanding of the present disclosure, the present disclosure could be implemented in other ways than the one described herein. Obviously, the embodiments of the present disclosure are only a part of the embodiments of the present disclosure, not all of them.

Nowadays, the support of the mask is typically formed of a hard plastic plate, and foam is arranged on the support to contact the user's face. When worn by a user, the mask mainly relies on deformation of the foam to match the user's face. However, due to a limited deformability, the foam has a low adaptability to users having different face shapes, thus leading to poor wearing experience.

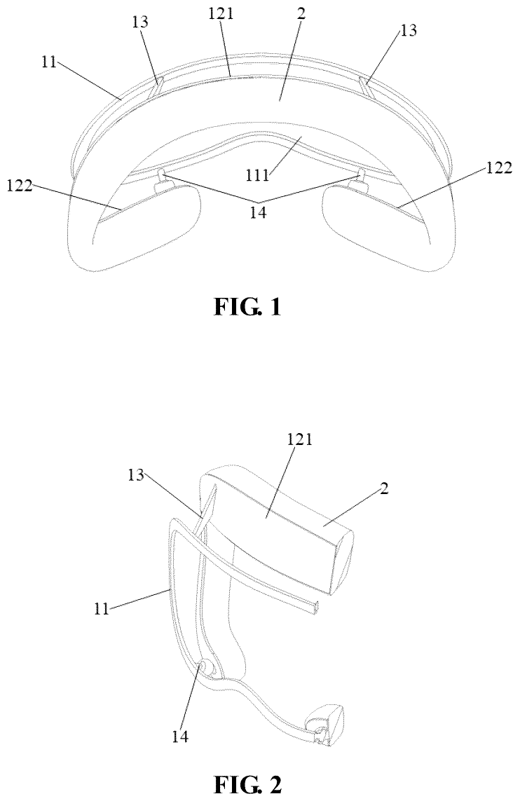

As shown in FIGS. 1-5, the embodiments of the present disclosure provide a mask 20 for a head-mounted display device, including a support 1. The support 1 extends in a first and a second direction orthogonal to each other. The support 1 includes a main support 11, and a face-fitting elastic support 12 that is disposed on one side of the main support 11 and arranged in a bent form. The main support 11 on both sides in the second direction is respectively provided with a forehead cantilever 13 and a zygomatic cantilever 14 that are connected with the face-fitting elastic support 12. There are provided two forehead cantilevers 13 that are spaced apart in the first direction, and can be elastically bent in the first direction, respectively. There are provided two zygomatic cantilevers 14 that are spaced apart in the first direction.

It would be appreciated that the face-fitting elastic support 12 on both sides in the second direction is connected to the main support 11 via the forehead cantilever 13 and the zygomatic cantilever 14, respectively; the face-fitting elastic support 12 in the middle is recessed towards the main support 11; the two forehead cantilevers 13 are spaced apart in the first direction, and can generate bending deformation in the first direction; the two zygomatic cantilevers 14 are spaced apart in the first direction, such that, when a user wears the mask, the face-fitting elastic support 12 can be adaptively deformed according to the face shape of the user; the forehead cantilevers 13 and the zygomatic cantilevers 14 function to support the face-fitting elastic support 12; the forehead cantilevers 13 are movable relative to the main support 11, and the face-fitting elastic support 12 is movable relative to the zygomatic cantilevers 14, to enable an adjustment to the force and the curvature of the face-fitting clastic support 12, such that the face-fitting clastic support 12 can better match face shapes of different users, thus improving the user experience. In other words, the face-fitting elastic support can be adaptively deformed according to face shapes of different users, and the forehead cantilevers are movable relative to the main support, such that the face-fitting clastic support can match face shapes of different users, to improve the user experience.

It should be noted that, when the head-mounted display device is worn, the first direction is a left-right direction, the second direction is an up-down direction, and the face-fitting clastic support 12 is located at a rear side of the main support 11. In other words, the first direction is the left-right direction relative to the user, the second direction is the vertical direction, the face-fitting clastic support 12 is located at the rear side of the main support 11 in the anterior-posterior direction relative to the user, and the main support 11 is located at the front side of the face-fitting clastic support 12 in the anterior-posterior direction relative to the user.

In addition, the face-fitting clastic support 12 described above is used to fit with the user's face, and the bending arrangement of the face-fitting clastic support 12 refers to that the face-fitting clastic support 12 is presented in an arc shape that can match the face shape of the user, such that the mask 20, when being worn, can fit the user's face. In the case, the face-fitting clastic support 12 in the middle in the first direction is recessed towards the main support 11.

Further, the mask 20 of the head-mounted display device further includes a face-fitting cushion 2 disposed on a side of the face-fitting elastic support 12 away from the main support 11. In other words, the face-fitting clastic support 12 is provided thereon with a face-fitting cushion 2 that can fit the user's face, such that the deformation of the face-fitting cushion 2 can enable the mask to better match the face shape of the user, thereby avoiding the problem of squeezing the user's face, or causing local light leakage.

It should be noted that the face-fitting cushion 2 may be formed of foam, sponge, or the like, which is light in weight and has a good elasticity, thus improving the wear comfort of the mask.

Referring to FIGS. 1 and 2, in the first direction, the distance of the connection points of the two forehead cantilevers 13 to the face-fitting clastic support 12 is less than the distance of the connection points of the two check-bone cantilevers 14 to the face-fitting clastic support 12.

It would be appreciated that the gap from the two forehead cantilevers 13 to the face-fitting clastic support 12 in the first direction is less than the gap from the two zygomatic cantilevers 14 to the face-fitting clastic support 12, which conforms to ergonomic design, i.e., which fits the natural shape of the human. Since the width of the forehead of the human being is less than the width between the zygomatic parts, the face-fitting cushion 2 on the face-fitting clastic support 12 can better match the forehead and the zygomatic parts of the user, which can improve the wear comfort.

Referring to FIGS. 1-3, in some embodiments, the face-fitting elastic support 12 is rotatably connected to the zygomatic cantilever 14 such that the face-fitting clastic support 12 can rotate at least in the first direction and/or the second direction relative to the zygomatic cantilever 14.

It would be appreciated that the face-fitting clastic support 12 is rotatably connected to the zygomatic cantilever 14 such that, when being deformed, the face-fitting clastic support 12 is free from the impact of the zygomatic cantilever 14, i.e., the face-fitting clastic support 12 can be deformed to match the user's zygomatic parts, which can enhance the adaptability of the face-fitting clastic support 12 with the user's face, and thus improve the wear comfort.

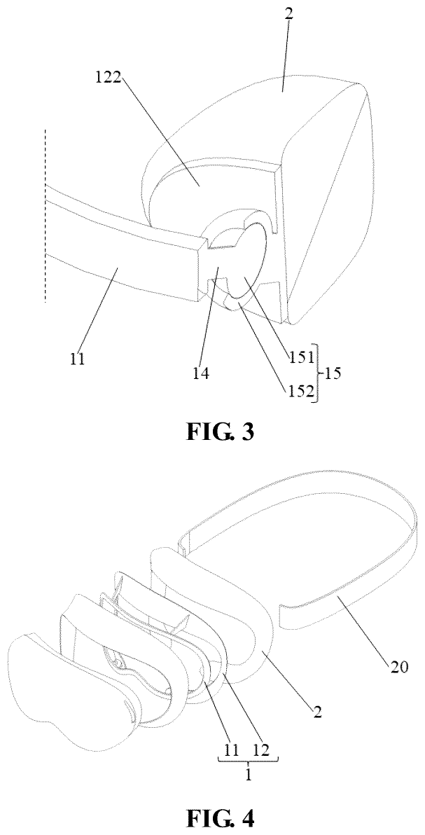

By way of example, in a specific implementation, referring to FIGS. 2 and 3, the face-fitting clastic support 12 and the zygomatic cantilever 14 is connected via the ball joint structure 15. Wherein, the ball joint structure 15 includes a ball seat 152 and a ball head 151, where a ball socket for receiving the ball head 151 is disposed on the ball seat 152, and the ball head 151 is rotatable within the ball socket. The ball head 151 is connected to the zygomatic cantilever 14, and the ball seat 152 is connected to the face-fitting clastic support 12, such that the face-fitting clastic support 12 can rotate via the ball joint structure 15 in multiple directions relative to the zygomatic cantilever 14, rather than limited to the first direction and the second direction. In this way, the face-fitting clastic support 12 can be deformed to match the user's zygomatic bone, which is not restricted by the zygomatic cantilevers 14.

Alternatively, the ball head is connected to the face-fitting elastic support, and the ball seat is connected to the zygomatic cantilevers.

Referring to FIGS. 1-3, in some embodiments, in the first direction, the two forehead cantilevers 13 are arranged symmetrically while the two zygomatic cantilevers 14 are arranged symmetrically. As a result, when the face-fitting clastic support 12 and the two forehead cantilevers 13 are elastically deformed, the deformation of the face-fitting clastic support 12 on both sides in the first direction can be kept as consistent as possible, to avoid partial non-fitting with the user's face, or partial pressure on the user's face, caused by a great deformation difference between the two sides of the face-fitting clastic support 12.

Referring to FIGS. 1-3, in some embodiments, the face-fitting clastic support 12 includes a main bracket 121, and separate brackets 122 connected to two ends of the main bracket 121 in the first direction, where the main bracket 121 has an arc shape and is recessed in the middle towards the main support 11, and the two separate brackets 122 form nose pad portions of the face-fitting clastic support 12. Wherein, the main bracket 121 is connected to two forehead cantilevers 13, and the two separate brackets 122 are respectively connected to the two zygomatic cantilevers 14.

It would be appreciated that when the mask 20 of the head-mounted display device is used, the nose pad portions can fit the nose, such that the mask is supported by the user's nose; the main bracket 121 fits the face, and main bracket 121 and the separate brackets 122 are deformed by the pressure from the face, to relieve the squeeze on the face; and the main bracket 121 can fit the face due to the reaction force of its own deformation, to ensure the wearing effect.

It should be noted that the main bracket 121 of the face-fitting clastic support 12 has an arc shape and is recessed in the middle towards the main support 11, i.e., the main bracket 121 is arranged in a bent form, such that the main bracket 121 can adapt to the shape of the human head, making it easier for the user to wear it, and the mask 20 can fit the user's face in a better effect.

Further, the separate bracket 122 is connected to the zygomatic cantilever 14 via the ball joint structure 15, such that, when deformed to match the user's zygomatic, the separate bracket 122 can be protected from being affected by the zygomatic cantilever 14, i.e., the separate bracket 122 can generate deformation to match the user's zygomatic part in a better effect, which is advantageous for improving the adaptability of the face-fitting clastic support 12 to the user's face, thereby further improving the wear comfort.

It would be appreciated that the face-fitting cushion 2 is arranged following the contour of the face-fitting clastic support 12, i.e., a part of the face-fitting cushion 2 is arranged on a side of the main bracket 121 away from the main support 11 while the remaining part is disposed on a side of the two separate brackets 122 away from the main support 11, to provide buffering when the user wears the mask and thus prevent the face-fitting elastic support 12 from hurting the user.

It is worth noting that the main bracket 121 and the two separate brackets 122 of the face-fitting elastic support 12 are formed integrally, which can reduce the number of parts while lowering the assembling difficulty. In the case, the face-fitting clastic support 12 can be formed by injection molding, and the material thereof may be selected from PC, PA, nylon, and the like. The main bracket 121 and the two separate brackets 122 of the face-fitting clastic support 12 can be formed separately. For example, the main bracket 121 and the two separate brackets 122 can be assembled into the face-fitting clastic support through a connection method which may include fusion, welding, bonding, screw connection, or the like.

Hereinafter, the process of using the mask will be described in detail.

In a first case: when the mask 20 is worn, if the user's forehead contour is greater than the curvature of the face-fitting clastic support 12, the middle part of the user's forehead first contacts the middle part of the main bracket 121. The force brings inward pressures onto the two forehead cantilevers 13, such that each forehead cantilever 13 generates clastic deformation in a direction towards the other forehead cantilever 13. In this way, the middle part of the main bracket 121 has an increased curvature, thus fitting the user's forehead having a large curvature. Meanwhile, for the zygomatic part, the separate bracket 122 generates deformation and can rotate relative to the zygomatic cantilever 14, so as to fit the user's zygomatic part.

Wherein, each forehead cantilever 13 is bent in the direction towards the other forehead cantilever 13 to generate clastic deformation, i.e., the left forehead cantilever 13 is bent and deformed rightwards while the right forehead cantilever 13 is bent and deformed leftwards. Each separate bracket 122 is driven by the main bracket 121 to swing relative to the corresponding zygomatic cantilever 14 in a direction away from the other separate bracket 122, i.e., the left separate bracket 122 rotates counterclockwise relative to the zygomatic cantilever 14 while the right separate bracket 122 rotates clockwise relative to the zygomatic cantilever 14. In a second case: when the mask 20 is worn, if the user's forehead contour is greater than the curvature of the face-fitting clastic support 12, the user's forehead at two sides first contacts the two sides of main bracket 121 in the first direction. The force brings outward pressures onto the two forehead cantilevers 13, such that each forehead cantilever 13 generates elastic deformation in a direction away from the other forehead cantilever 13. In this way, the middle part of the main bracket 121 has a decreased curvature, thus fitting the user's forehead having a small curvature. Meanwhile, for the zygomatic part, the separate bracket 122 generates deformation and can rotate relative to the zygomatic cantilever 14, so as to fit the user's zygomatic part.

Wherein, each forehead cantilever 13 is bent in the direction away from the other forehead cantilever 13 to generate clastic deformation, i.e., the left forehead cantilever 13 is bent and deformed leftwards while the right forehead cantilever 13 is bent and deformed rightwards. Each separate bracket 122 is driven by the main bracket 121 to swing relative to the corresponding zygomatic cantilever 14 in a direction towards the other separate bracket 122, i.e., the left separate bracket 122 rotates clockwise relative to the zygomatic cantilever 14 while the right separate bracket 122 rotates counterclockwise relative to the zygomatic overhanding arm 14.

In some embodiments, the forehead cantilever 13 includes a first cantilever and a second overhanding arm connected to each other, where the first cantilever is connected to the main support 11, the second cantilever is connected to the face-fitting clastic support 12, the first arm is in a sheet form, and the plane where the first arm is located is not parallel with the first direction. Specifically, the second cantilever is connected to the main bracket 121 of the face-fitting clastic support 12.

It would be appreciated that, for the arrangement described above (specifically, the forehead cantilever 13 includes a first cantilever and a second overhanding arm connected to each other, where the first cantilever is connected to the main support 11, the second cantilever is connected to the face-fitting clastic support 12, the first arm is in a sheet form, and the plane where the first arm is located is not parallel with the first direction), the sheet form of the first cantilever can make it easier for the forehead cantilever 13 to generate elastic deformation in the first direction when a force is applied to the face-fitting elastic support 12.

Furthermore, one end of the second cantilever is connected to the first cantilever, and the other end thereof extends in the first direction away from the other forehead cantilever 13 and is connected to the face-fitting clastic support 12.

It would be appreciated that, since the other end of the second cantilever extends away from the other forehead cantilever 13, the second cantilevers of the two forehead cantilevers 13 are in a splayed form, which can increase the distance of the two connection points of the two forehead cantilevers 13 to the face-fitting elastic support 12 in the first direction, improve the support stability of the forehead cantilever 13 to the face-fitting clastic support 12, and fit the user's face in a better effect to facilitate transmission of the force to the first cantilever.

It is worth noting that, in the circumstance where the second cantilever is in the sheet form and the plane where the second cantilever is located is not vertical to the first direction, the shape of the second cantilever can be kept stable when the forehead cantilever 13 is driven by the face-fitting clastic support 12 to generate deformation, so as to transmit the force to the first cantilever, and thus bend and deform the first cantilever.

In some embodiments, the forehead cantilever is rotatably connected to the face-fitting elastic support, and thus can swing in the first direction relative to the face-fitting elastic support.

It would be appreciated that, since the forehead cantilever is rotatably connected with the face-fitting elastic support, the forehead cantilever and the face-fitting elastic support can rotate relative to each other when the face-fitting clastic support is pressed to be deformed and the forehead cantilever is deformed, so as to avoid mutual interference and affect the deformation of the face-fitting elastic support.

By way of example, in a specific implementation, the forehead cantilever is connected to the face-fitting elastic support by a connector extending in the vertical direction, and can rotate about the connector, where the connection may be a screw, or a bolt.

It is worth noting that the second cantilever of the foresaid cantilever is rotatably connected to the main bracket of the face-fitting elastic support.

Referring to FIGS. 1-3, in some embodiments, the main support 11 has an annular shape, i.e., the main support 11 is formed with a through hole. The through hole is configured to correspond to two display modules of a display unit 10 of the head-mounted display device, to allow the user to watch videos via the through hole formed by the main bracket 11 when wearing the head-mounted display device.

Alternatively, in some other embodiments, the main support 11 is provided with two through holes spaced apart in the first direction. The space enclosed by the face-fitting clastic support 12 covers the two through holes.

Wherein, the through holes are configured to correspond to two display modules of the display unit 10 of the head-mounted display device, and the space enclosed by the face-fitting elastic support 12 covers the two through holes, such that the user's eyes correspond to the two through holes when the head-mounted display device is worn, to enable the user to watch the images presented by the display modules.

Alternatively, in some embodiments, the main support 11 on both sides in the first direction is provided with a side panel bracket (not shown), and the face-fitting elastic support 12 is disposed between the two side panel brackets in the first direction.

The side panel brackets can fix the straps of the head-mounted display device, or can fix the housing of the head-mounted display device, to thus enhance the overall structural strength of the head-mounted display device.

The embodiments of the present disclosure further provide a head-mounted display device including the mask 20 of the head-mounted display device, as described above. The head-mounted display device can achieve the technical effect of the mask according to the above-mentioned embodiments. Details thereof are omitted herein for brevity.

It is worth noting that the head-mounted display device may be AR glasses, VR glasses, MR glasses, and the like, which is not specifically limited herein.

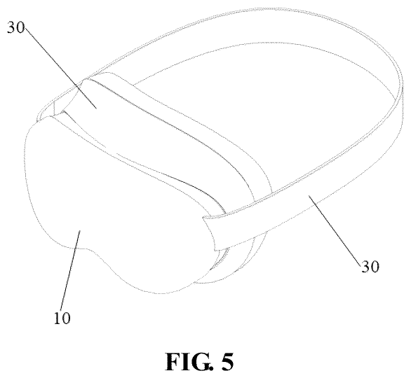

Referring to FIGS. 4 and 5, the head-mounted display device further includes a display unit 10 that can be connected to the support. When wearing the head-mounted display device, the user can watch videos through the display unit 10.

In addition, in order to avoid light leakage, a light shielding member is disposed between the display unit and the mask 20. The light shielding member has a cylindrical shape, and is connected on one end to the display unit 10 while connected on the other end to the face-fitting elastic support 12. The material of the light shielding member may be plastic or cloth.

Furthermore, the head-mounted display device further includes straps 30 that are connected to the display unit 10, to enable the user to stably wear the head-mounted display device.

It is worth noting that the relationship terms as used herein, for example, “first”, “second”, and the like, are only intended for distinguishing an entity or operation from a further entity or operation, but not necessarily require or imply that those entities or operations should have any of such actual relationships or orders. In addition, the terms “include”, “comprise”, or any other variant thereof are intended to cover a non-exclusive inclusion, such that a process, method, article, or device including a series of elements not only include those elements, but also cover other elements not listed explicitly, or further cover inherent elements of the process, method, article, or device. Unless specified otherwise, elements defined by the expression “including one . . . ” do not exclude presence of additional identical elements in the process, method, article, or device including those elements.

The previous description of the disclosed embodiments is provided to enable those skilled in the art to implement or apply the present disclosure. Various modifications to these embodiments will be readily apparent to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

I/We claim:

1. A mask of a head-mounted display device, comprising:
a support extending in a first direction and a second direction orthogonal to each other, the support comprising a main support, and a face-fitting elastic support that is disposed on a side of the main support and arranged in a bent manner,
the main support being provided with a forehead cantilever and a zygomatic cantilever connected to the face-fitting elastic support on both sides respectively in the second direction, and two forehead cantilevers being provided and arranged at an interval in the first direction, and the forehead cantilever being capable of elastically bending in the first direction, and two zygomatic cantilevers being provided and arranged at an interval in the first direction.

2. The mask of the head-mounted display device of claim 1, wherein the forehead cantilever comprises a first cantilever and a second cantilever connected to each other, and the first cantilever is connected to the main support, the second cantilever is connected to the face-fitting elastic support, the first cantilever is in a sheet form, and a plane on which the first cantilever is located is not parallel to the first direction.

3. The mask of the head-mounted display device of claim 2, wherein an end of the second cantilever is connected to the first cantilever, and the other end thereof extends in the first direction away from the other forehead cantilever and is connected to the face-fitting elastic support.

4. The mask of the head-mounted display device of claim 1, wherein the forehead cantilever is rotatably connected to the face-fitting elastic support, and the forehead cantilever is capable of swinging in the first direction relative to the face-fitting elastic support.

5. The mask of the head-mounted display device of claim 1, wherein the face-fitting elastic support is rotatably connected to the zygomatic cantilever, such that the face-fitting elastic support is capable of rotating at least in the first direction and/or the second direction relative to the zygomatic cantilever.

6. The mask of the head-mounted display device of claim 5, wherein the mask of the head-mounted display device further comprises a ball joint structure, and the ball joint structure comprises a ball seat and a ball head, and the ball seat is provided thereon with a ball socket for receiving the ball head, and one of the ball head and the ball seat is connected to the zygomatic cantilever while the other is connected to the face-fitting elastic support.

7. The mask of the head-mounted display device of claim 1, wherein the face-fitting elastic support comprises a main bracket and separate brackets connected to two ends of the main bracket in the first direction, and the main bracket has an arc shape and is recessed in a middle part towards the main support, and the two separate brackets form nose pad portions of the face-fitting elastic support;
wherein the main bracket is connected to the two forehead cantilevers, and the two separate brackets are connected to the two zygomatic cantilevers respectively.

8. The mask of the head-mounted display device of claim 1, wherein, in the first direction, a distance between connection points of the two forehead cantilevers with the face-fitting elastic support is less than a distance between connection points of the two zygomatic cantilevers with the face-fitting elastic support.

9. The mask of the head-mounted display device of claim 1, wherein the mask of the head-mounted display device further comprises a face-fitting cushion disposed on a side of the face-fitting elastic support away from the main support.

10. A head-mounted display device, wherein the head-mounted display device comprises a mask comprising:
a support extending in a first direction and a second direction orthogonal to each other, the support comprising a main support, and a face-fitting elastic support that is disposed on a side of the main support and arranged in a bent manner,
the main support being provided with a forehead cantilever and a zygomatic cantilever connected to the face-fitting elastic support on both sides respectively in the second direction, and two forehead cantilevers being provided and arranged at an interval in the first direction, and the forehead cantilever being capable of elastically bending in the first direction, and two zygomatic cantilevers being provided and arranged at an interval in the first direction.

11. The device of claim 10, wherein the forehead cantilever comprises a first cantilever and a second cantilever connected to each other, and the first cantilever is connected to the main support, the second cantilever is connected to the face-fitting elastic support, the first cantilever is in a sheet form, and a plane on which the first cantilever is located is not parallel to the first direction.

12. The device of claim 11, wherein an end of the second cantilever is connected to the first cantilever, and the other end thereof extends in the first direction away from the other forehead cantilever and is connected to the face-fitting elastic support.

13. The device of claim 10, wherein the forehead cantilever is rotatably connected to the face-fitting elastic support, and the forehead cantilever is capable of swinging in the first direction relative to the face-fitting elastic support.

14. The device of claim 10, wherein the face-fitting elastic support is rotatably connected to the zygomatic cantilever, such that the face-fitting elastic support is capable of rotating at least in the first direction and/or the second direction relative to the zygomatic cantilever.

15. The device of claim 14, wherein the mask of the head-mounted display device further comprises a ball joint structure, and the ball joint structure comprises a ball seat and a ball head, and the ball seat is provided thereon with a ball socket for receiving the ball head, and one of the ball head and the ball seat is connected to the zygomatic cantilever while the other is connected to the face-fitting elastic support.

16. The device of claim 10, wherein the face-fitting elastic support comprises a main bracket and separate brackets connected to two ends of the main bracket in the first direction, and the main bracket has an arc shape and is recessed in a middle part towards the main support, and the two separate brackets form nose pad portions of the face-fitting elastic support;
wherein the main bracket is connected to the two forehead cantilevers, and the two separate brackets are connected to the two zygomatic cantilevers respectively.

17. The device of claim 10, wherein, in the first direction, a distance between connection points of the two forehead cantilevers with the face-fitting elastic support is less than a distance between connection points of the two zygomatic cantilevers with the face-fitting elastic support.

18. The device of claim 10, wherein the mask of the head-mounted display device further comprises a face-fitting cushion disposed on a side of the face-fitting elastic support away from the main support.

19. The device of claim 10, wherein the device comprises a display unit.

20. The device of claim 10, wherein the device comprises one of AR glasses, VR glasses or MR glasses.
